(19) United States
(12) Patent Application Publication
(10) Pub. No.: US 2026/0229858 A1
(43) Pub. Date: Aug. 6, 2026

(54) TOOL AND METHOD FOR PREPARATION OF FLEXIBLE ARMORED CABLE & CONDUIT

(71) Applicant: Robert Frank Bedsole, Downers Grove, IL (US)

(72) Inventor: Robert Frank Bedsole, Downers Grove, IL (US)

(73) Assignee: ADCOM TECHNOLOGIES INCORPORATED, DOWNERS GROVE, IL (US)

(21) Appl. No.: 19/530,300

(22) Filed: Feb. 4, 2026

Related U.S. Application Data
(60) Provisional application No. 63/833,995, filed on Feb. 5, 2025.

(51) Int. Cl. H02G 1/12

(52) U.S. Cl. CPC H02G 1/1229

(57) ABSTRACT

A tool and method for preparing flexible armored cable and conduit that includes elements for power-assisted armor cutting, wire cutting, wire insulation stripping and conductor end loop forming. Comprised in part of a body and handle through which a drivable shaft carrying a circular armor cutting blade is rotatably mounted for power assisted armor cutting. Pivotally attached to the body is a lever, nest jaw and clamp plates to position, securely clamp and feed the cable or conduit into the blade to cut the armor. Cutting blades linked between the lever and body provide compounded leverage to readily cut large or multiple conductors. A stripper aperture removes insulation from the ends of conductors. Looping apertures are provided to produce uniform semi-circular loop forms on stripped conductor ends for secure termination on common electrical wiring devices. Drive bit storage, spare blade storage and utility hook provisions provide user convenience.

### CROSS-REFERENCE TO RELATED APPLICATIONS

This application is a non-provisional application which claims the benefit of priority to U.S. Provisional Application No. 63/833,995 filed 2025 Feb. 5 by the present inventor, and the entire contents of which are herein incorporated by reference.

### FEDERALLY SPONSORED RESEARCH

Not Applicable

### SEQUENCE LISTING OR PROGRAM

Not Applicable

### BACKGROUND

### Field of the Invention

This application relates to tools and methods used in the preparation of electrical cables, conduits and wires, particularly hand-held manual and power-assisted portable tools for cutting, stripping & forming flexible armored cable, conduit and wires contained therein.

### Prior Art

Flexible armored cable and conduit are common electrical materials that find widespread use in building wiring, machine wiring, appliance wiring and other similar applications where confined spaces and obstructions make non-flexible or rigid conduit installation impossible or impractical. They provide protection from damage to the electrical conductors contained within them while also allowing for a degree of displacement or motion between the devices being electrically connected. Such is the case when the attached equipment may need to be moved for servicing or accessibility, or where vibration between attached equipment needs to be isolated.

Use of such flexible armored cable and conduit is widely established in the electrical trade and is recognized by relevant standards, codes and regulatory bodies. Common industry names include ‘BX”, “AC”, “Greenfield”, “MC” and “FMC” which may be broadly categorized as either flexible armored cable (flexible armored conduit containing conductors) or simply flexible armored conduit (flexible armored conduit without conductors contained). The flexible armor of these cables and conduits is commonly constructed from metallic strip stock that is spirally wound and interlocked upon itself at the edges to form a nominally cylindrical cavity within which one or more electrical conductors may be carried.

All of these flexible armored cables and conduits are supplied in bulk coils from which a needed length is cut and prepared for use in a particular application. As such, the installer must first cut through a portion of the armor to separate the desired section from the coil. Next, in the case of cable, the armor must be separated at the armor cut to expose contained conductors, and they are cut nominally perpendicular to the armor length. The cut ends of insulated conductors must then typically be stripped of insulation for the purpose of making electrically conductive connections. As a final step, the stripped conductor ends may be formed into a loop to provide added retention on screw terminals of attached equipment or wiring devices

Complete preparation of a section of these flexible armored cables and conduits thus presents a time consuming and laborious series of operations requiring several tools including an armor cutter, wire cutters, wire strippers, and pliers.

Early use of these armored cables and conduit did not directly address the issues of preparing the armor and conductors for installation & connection. As a result, installers were left to find best methods using whatever tools were at their disposal. These methods used hacksaws, wire cutters, wire strippers or knives, and pliers to provide adequate results, but were time consuming, awkward, laborious and potentially unsafe.

Prior art patents address some of these issues with varying degrees of success, the disclosures of which are herein incorporated by reference (see References Cited in tabulated form below). Many present tools with a rotatable armor cutting blade to improve on the singular step of cutting through the armor with a common hacksaw or similar tool. Most of these include a body or framework to support or position the armored cable or conduit relative to the blade, and a hand crank to provide power to rotate the blade (ref. U.S. Pat. Nos. 2,031,470; 2,654,941; 3,851,387; 4,142,290; 4,359,819; 4,697,343; 4,753,007; 4,769,909; 4,884,339; 4,977,671; 7,891,097; 8,112,893; 8,191,266; 9,088,144; 9,136,677; 12,294,204). Others are intended as bench or stationary equipment rather than handheld or portable tools (ref. U.S. Pat. Nos. 2,396,442; 4,055,097; 4,103,578; 4,169,400; 4,267,636; 5,487,220; 5,809,652). Some provide powered drive to the armor cutting blade, but again address only the singular armor cutting function (ref. U.S. Pat. Nos. 3,633,275; 4,062,110; 4,979,307; 5,070,615; 6,044,744; 8,522,440; 9,270,095; 10,033,167). Still other related tools provide means for stripping assorted jackets and insulations from specialty or non-armored cables by way of rotary or straight knives, again without providing a complete cable preparation means (ref. U.S. Pat. Nos. 2,659,140; 3,703,035; 4,489,490; 5,337,479; 5,491,894; 6,073,349; 6,662,450; 9,153,364).

While improving on the earlier make-shift methods that used common tools, these prior art patent solutions remained laborious, awkward and time-consuming solutions to the singular task of cutting the armor or stripping wire while not addressing other steps necessary for the complete preparation of armored cable and conduit.

### SUMMARY

As seen in comparison, the tool and method disclosed herein thus presents an inventive single, handheld portable tool capable of complete preparation of flexible armored cables and conduits in a fast, power assisted, economical and safe manner not seen in prior art.

Specifically, the tool is readily held in hand by the user and is of size and weight to make it readily portable. It further includes provision for power assisted drive of the armor cutting blade. It further still offers combined operational actions by way of a lever to locate, clamp, feed and release an armored workpiece, as well as to cut conductors carried within the workpiece. Further still it includes conductor stripping and loop forming elements.

As thus described, the tool and method disclosed herein overcomes the shortcomings of prior art tools and methods by completely preparing flexible armored cables and conduits that are ready for installation.

### DESCRIPTION OF DRAWINGS

FIG. 1 is an isometric view of the first embodiment of the tool showing armor cutting, wire cutting, wire stripping and conductor end looping elements, with example armored cable sections.

FIG. 2 is an isometric exploded view showing components comprising the first embodiment of the tool, with three pivot axes denoted as A-A, B-B and C-C shown at the body and at other components sharing those pivot axes.

FIG. 3 is a partial assembly sectioned side view of the first embodiment of the tool showing the rotational drive elements and circular armor cutting blade.

FIG. 4 is an enlarged detail view from FIG. 3 of the first embodiment of the power-assisted armor cutting drive mechanism and mating hex shank drive bit.

FIG. 5 is an enlarged detail view from FIG. 3 of the armor cutting blade & shaft as carried within the handle and body by the rolling element bearing and its locating elements.

FIG. 6 is a partial assembly sectioned side view showing the first embodiment of the power-assisted armor cutting function comprising a hex shank driver bit in a user-supplied drill/driver (in phantom).

FIG. 7 is a partial assembly sectioned side view of a second embodiment of the power-assisted armor cutting function comprised of a contained motor, gear reducer and rechargeable batteries.

FIG. 8 is a partial assembly sectioned side view of a third embodiment of the power-assisted armor cutting function comprised of a contained motor and gear reducer with rechargeable batteries provided in a detachable battery pack.

FIG. 9 Is a partially sectioned side view of the tool in the fully closed & unloaded position showing connection and interaction of internal locating, clamping and cutting components.

FIG. 10 Is an enlarged isometric view of transfer cam 62 with integral detent 105.

FIG. 11 is a side view of the tool body with nest jaw and clamp plates in their fully closed end-of-travel position.

FIG. 12 is a partially sectioned side view of the tool in the fully open position, showing connection and interaction of internal locating, clamping and cutting components.

FIG. 13 is a partial assembly side view of the tool showing the body with lever, nest jaw and clamp plates in the fully open position.

FIG. 14 is a partial assembly side view showing the tool body with nest jaw and clamp plates in their fully open position with a section of armored cable loaded into the nest jaw.

FIG. 15 is an isometric view detailing the nest jaw, clamp plates, perch studs and clamp spring.

FIG. 16 is a side view detail illustrating the independent angular articulation of the clamp plates with respect to the nest jaw.

FIG. 17 is an isometric detail view of the clamp plates self-adjusting with respect to the nest jaw to engage and clamp upon the undulate outer surface of a common size and form of steel armored cable.

FIG. 18 is an isometric detail view of the clamp plates self-adjusting with respect to the nest jaw to engage and clamp upon the undulate outer surface of a common size and form of aluminum armored cable.

FIG. 19 is a partially sectioned side view of the tool showing the lever in the closed position with nest jaw and clamp plates closed and clamped upon a section of armored cable that is being fed into the armor cutting blade.

FIG. 20 is an enlarged, partially sectioned side view of the tool illustrating the adjustable depth-of-cut stop stud acting against the tool body at completion of the armor cutting operation.

FIG. 21 is an isometric view of the tool shown in the open position with nip blades positioned to cut the wires of a cable that has had the armor cut and separated.

FIG. 22 is a partial assembly side view illustrating the compound lever-action of the nip blades, with an armored cable & wires positioned for wire cutting & stripping operations.

FIG. 23 an isometric view of the lever showing elements of the first embodiment of the wire insulation stripper aperture as integral to the lever.

FIG. 24 is an enlarged cross-sectional view taken from FIG. 22 of the first embodiment wire insulation stripper aperture with a stripped wire end in place.

FIG. 25 is an isometric detail of a second embodiment of the wire stripper aperture made to be removable and replaceable.

FIG. 26 is a side view detail illustrating installation & removal of the replaceable stripper aperture embodiment.

FIG. 27 is an isometric detail of the replaceable stripper aperture embodiment as installed on the lever, and the utility hook provision with a hook (in phantom) attached.

FIG. 28 is an isometric view of the tool showing the parts & procedure for loop forming the stripped conductor end of an insulated wire.

FIG. 29 is an isometric detail view of an example wire after end loop forming.

FIG. 30 is a partial assembly sectioned side view of the tool body showing the integral spare blade storage, a spare blade, and the retaining clip in place.

FIG. 31 is a partial assembly sectioned side view of the tool body showing the first embodiment of the spare blade storage feature comprised of a slide action spring clip.

FIG. 32 is a partial assembly sectioned side view of the tool body showing the second embodiment of the spare blade storage feature comprised of a flexural action spring clip.

FIG. 33 is an obverse side isometric view of the tool showing features not readily visible in other figures.

FIG. 34 is an enlarged detail from the obverse view of FIG. 33.

### DETAILED DESCRIPTION OF THE TOOL & METHOD

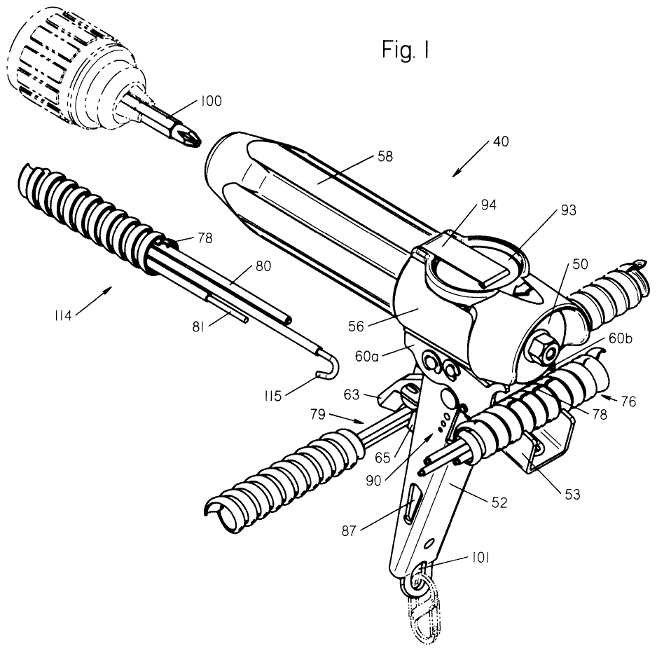

Referring to FIG. 1, tool 40 is comprised in part of handle 58, body 56, armor cutting blade 50, lever 52, nest jaw 53, clamp plates 60a & 60b, upper nip blade 63, lower nip blade 65, a stripper aperture 87, and looping apertures 90. Spare armor cutting blade(s) 93 are shown to be stored and retained in body 56 by spring clip 94. Stripper aperture 87 and ovoid hole 101 for a utility hook (phantom) are seen as integral to lever 52. Hex shank driver bit 100 is seen installed in the chuck of a user-supplied power drill/driver (in phantom) for the purpose of rotationally driving armor cutting blade 50 under power. An armored cable 76 is seen in position within nest jaw 53 upon completion of armor cut 78. Conductors 79 of a cut & separated section of armored cable are shown exposed and inserted between upper and lower nip blades 63 & 65 for cutting of said conductors. An example section of the resulting prepared flexible armored cable 114 after armor cutting, wire cutting, wire end stripping & end loop forming is shown as the result.

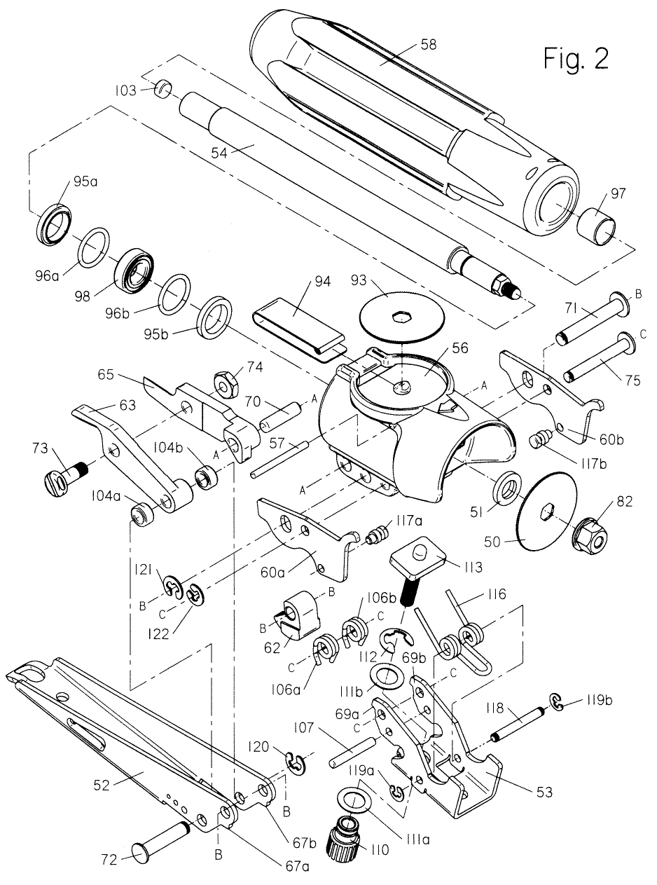

In FIG. 2 an exploded isometric view shows all components of the invented tool. Three pivot axes common to multiple parts are denoted A-A, B-B and C-C and are shown at the body and at the components sharing them.

### Armor Cutting

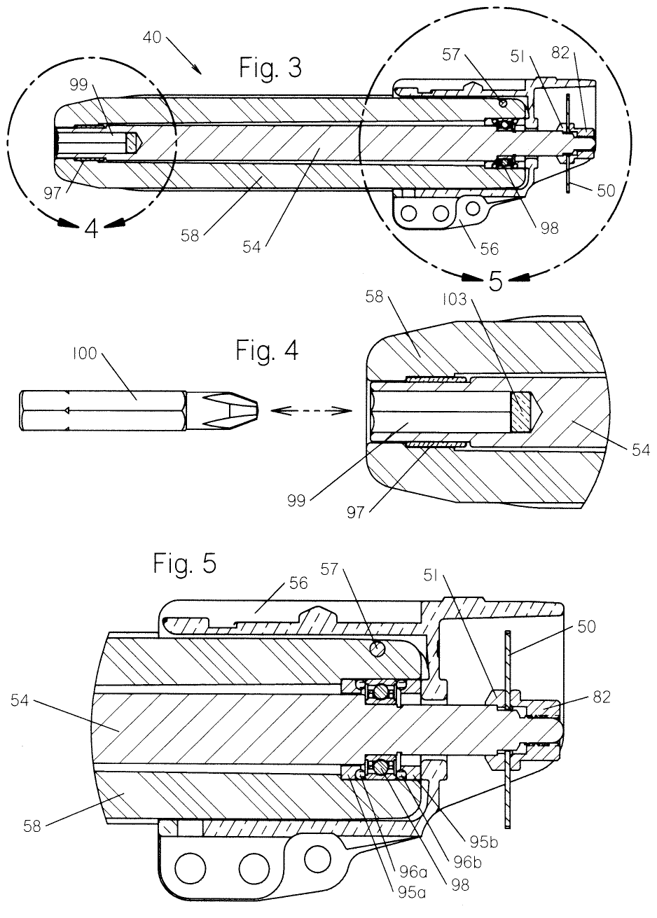

Referring to FIG. 3, shaft 54 is shown to pass through the cylindrical bore of handle 58 and is rotatably supported at the end proximal to body 56 by rolling element bearing 98 and at the opposite distal end by plain bearing 97. Circular armor cutting blade 50 includes a concentrically located opening of polygonal or keyed shape that mates to the body end of shaft 54 such that rotational power may be effectively transmitted from shaft 54 to blade 50. The cutting tooth form of blade 50 is of the type common to metal cutting hack saw blades. Upon installation on shaft 54, armor cutting blade 50 locates against flange ring 51 and is retained by flange nut 82. As readily understood, other embodiments could replace flange nut 82 with a threaded screw or other fastener to provide retention of blade 50 to shaft 54 without altering functionality. Within the distal end of shaft 54 is hexagonal recess 99. Retaining pin 57 maintains assembly of these elements relative to body 56.

In the enlarged detail of FIG. 4, hexagonal recess 99 is seen to be of predetermined depth to accept an ordinary hex shank driver bit 100 as commonly used to install threaded fasteners. In use, the driver bit engages hexagonal recess 99 on the hexagonal shank surfaces rather than on the fastener drive surfaces to transmit rotational power to the shaft. Permanent magnet 103 is fixedly mounted at the bottom of the hexagonal recess and provides a retaining force for the purpose of storing hex shank driver bit 100 at the ready.

As shown in the enlarged detail of FIG. 5, rolling element bearing 98 is retained longitudinally on shaft 54 with a press fit at the inner race, and within handle 58 between elastomeric rings 96a & 96b and backing rings 95a & 95b at the outer race. Upon assembly with body 56, elastomeric rings 96a & 96b are made to contact opposite faces of the outer race of rolling element bearing 98 by way of backing rings 95a & 95b, thereby locating the shaft nominally along the longitudinal axis of the tool and frictionally fixing the outer race of rolling element bearing 98 against rotation. Assembly and contact between these components are maintained by retaining pin 57 which passes co-axially through body 56 and handle 58.

Shaft 54 and armor cutting blade 50 are thereby restrained longitudinally while remaining free to rotate about their common primary axis. The shaft and blade are further provided with a degree of axial compliance owing to the compressibility of elastomeric rings 95a & 95b such that side loads on the blade can incrementally displace the shaft and blade along their longitudinal axis rather than adversely loading the blade itself.

As thus described, these components comprise the elements used to rotatably drive armor cutting blade 50 under power for the purpose of cutting the armor portion of a flexible armored cable or conduit.

### Power Assisted Blade Drive

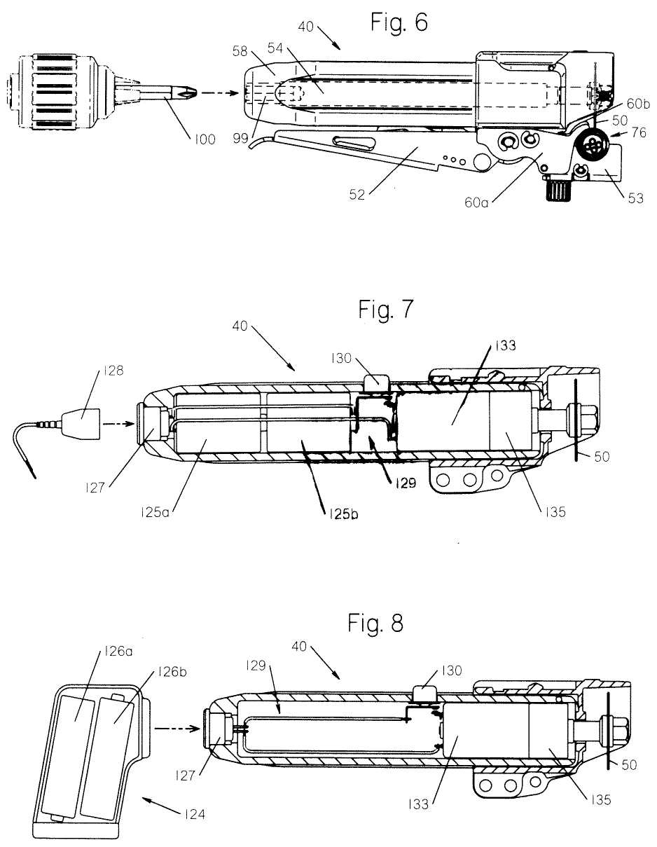

FIG. 6 shows a first embodiment of tool 40 in use for cutting the armor of a section of armored cable 76 with power assist. Armored cable 76 has been loaded into nest jaw 53 and lever 52 is rotated to the closed position parallel to and against handle 58, thereby securing the armor between clamp plates 60a & 60b and nest jaw 53. The armor section is now forced into contact with and pre-loaded against armor cutting blade 50 by feed springs 106a & 106b and will self-feed into blade 50 as it rotates to cut through the armor. Hex shank driver bit 100 is retrieved from storage in hexagonal recess 99 and installed in the chuck of a common corded or cordless electric drill/driver provided by the operator (shown in phantom). With tool 40 being held in this closed position by the operator, the free end of hex shank driver bit 100 bit is re-inserted into hexagonal recess 99 of shaft 54 and power is applied to the drill/driver. Armor cutting blade 50 is thus rotatably driven under power as armored cable 76 is fed into the rotating blade, thereby rapidly cutting through the armored cross section of said cable or conduit with minimal manual effort.

Referring to FIG. 7, a second embodiment is shown wherein the tool 40 contains a motor 133, gear reducer 135 and rechargeable batteries 125a & 125b to provide rotary power drive to armor cutting blade 50. Charging cable 128 is inserted into connector 127 for the purpose of recharging the batteries. Appropriate electrical connections are by wiring elements 129. Switch 130 is used by the operator to activate the motor thereby rotatably driving blade 50 to cut the armor under power. This embodiment provides a means for powering the tool without need for a separate drill/driver without affecting the other inventive features of the tool.

Referring to FIG. 8, a third embodiment of the tool 40 incorporating motor 133, gear reducer 135, connector 127, switch 130 and wiring elements 129, but with rechargeable batteries 126a & 126b incorporated into detachable battery pack 124 is shown. Switch 130 is again used to activate the motor thereby rotatably driving blade 50 to cut the armor under power. Such detachable battery packs are common and as with the embodiment of FIG. 7, provides a means for powering the tool without need for a separate drill/driver while not affecting the other inventive features of the tool.

### Lever Action and Resultant Generated Actions

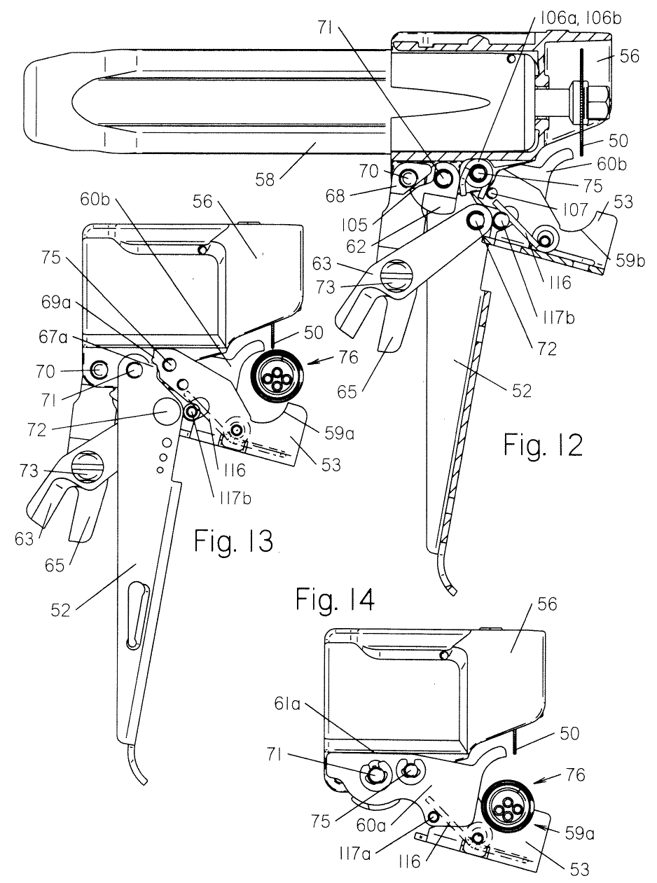

Referring to FIG. 2, lever 52 is pivotably connected to body 56 by pivot pin 71, which is retained by clip 121. Nest jaw 53 and clamp plates 60a and 60b are seen to be pivotably connected to body 56 by pivot pin 75, which is retained by clip 122. The motion of lever 52 is constrained to a nominal angular displacement of 90 degrees as measured from a fully closed position parallel to and against handle 58, to a fully open position orthogonal to handle 58, as seen in FIG. 12. Armor loading, armor clamping, armor in-feed during cutting and conductor cutting actions are generated by the tool operator applying manual forces between lever 52 and handle 58 to rotate lever 52 clockwise or counterclockwise through this nominal 90-degree range of motion as described below.

### Lever Closed Position

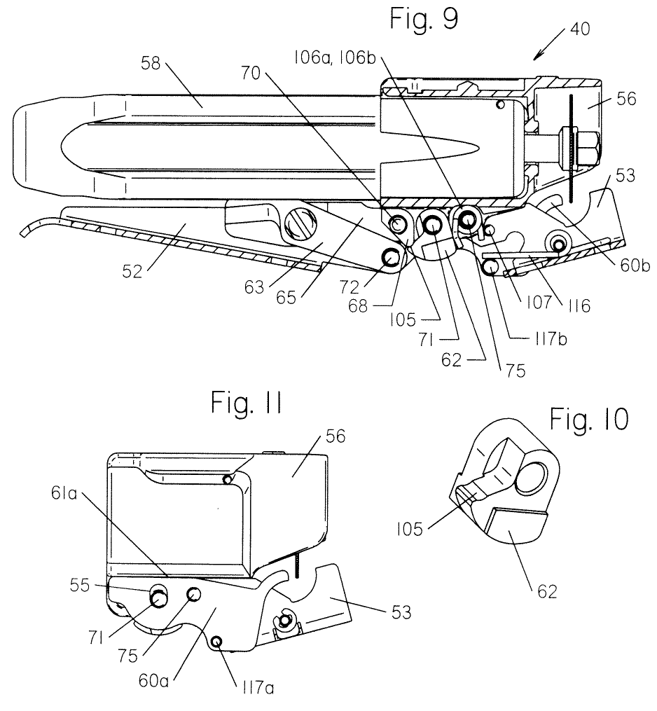

Referring to FIG. 9, the complete assembly of tool 40 is shown in a partially sectioned side view. Lever 52 is rotated on pivot pin 71 into the closed position parallel to and against handle 58. Upper nip blade 63 and lower nip blade 65 with integral drive cam 68 are closed and moved into position parallel to handle 58 owing to their connection to lever 52 with pivot pin 72 and to body 56 with dowel 70, respectively. Transfer cam 62 with integral detent 105, shown enlarged in FIG. 10, is rotated fully counterclockwise about pivot pin 71 by the drive cam 68, thereby compressing torsional feed springs 106a & 106b. This position is maintained by a fractional force acting over center between the drive cam 68 and detent 105 of transfer cam 62. In this closed position, nest jaw 53 is rotated counterclockwise about pivot pin 75 owing to reaction forces from feed springs 106a & 106b acting on spring stop 107.

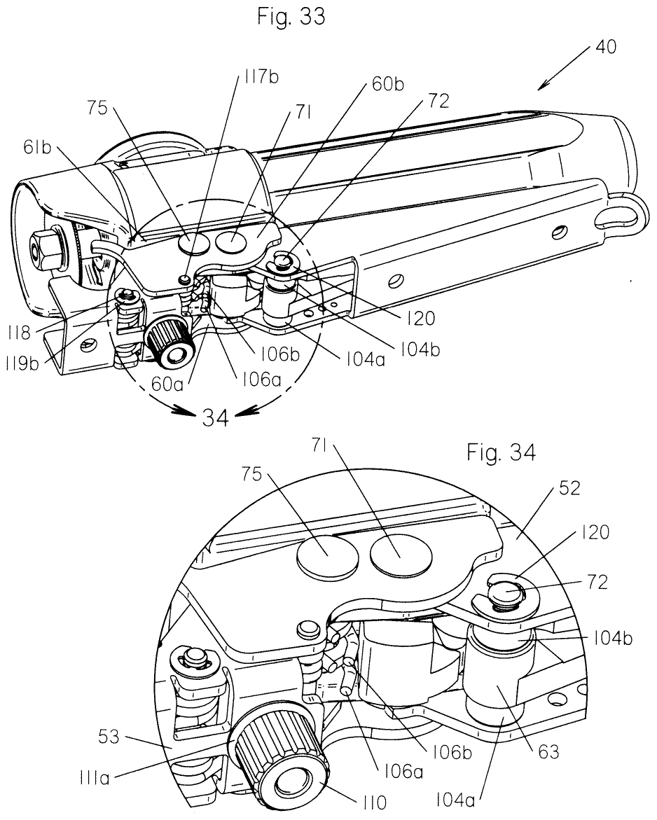

Simultaneously, as seen in FIGS. 9 & 11, clamp plates 60a and 60b are independently rotated clockwise about pivot pin 75 by forces applied to perch studs 117a & 117b by the end legs of clamp spring 116. In FIG. 11, near side clamp plate 60a is shown rotated fully clockwise and nest jaw 53 rotated fully counterclockwise about pivot pin 75 as described, to their respective end-of-travel positions wherein they contact body 56 at stop edge 61a. In FIG. 33 the equivalent stop edge 61b can be seen to provide the same end-of-travel limit to clamp plate 60b and nest jaw 53 on the obverse side of tool 40. Elongate hole 55, present in both clamp plates 60a & 60b provides clearance for pivot pin 71 during these motions.

This position, with lever 52 fully closed and the interconnected parts positioned as described, but without any armored cable or conduit loaded for cutting, represents a static, lever closed position of tool 40.

### Lever Open Position

Referring to FIGS. 12 through 14, rotation of lever 52 counterclockwise about pivot pin 71 to the fully open position perpendicular to handle 58 carries upper nip blade 63 counterclockwise about pivot pin 71 by way of its' connection at pivot pin 72. Lower nip blade 65 follows as a result of its' connection to upper nip blade 63 at shoulder bolt 73, rotating counterclockwise about dowel 70. Thus, a first resultant of fully opening lever 52 is to open nip blades into position for cutting of wires.

As lower nip blade 65 rotates counterclockwise about dowel 70, integral drive cam 68 travels out of contact with detent 105 and away from the left side profile of transfer cam 62. As a result, transfer cam 62 is free to rotate clockwise about pivot pin 71 and does so as a result of the loads applied by feed springs 106a and 106b acting between it and spring stop 107. Thus, a second resultant of opening lever 52 is to relax feed springs 106a and 106b.

Concurrent with the relaxing of feed springs 106a and 106b that occurs during the opening of lever 52, spur 67a of lever 52 engages with boss 69a of nest jaw 53 to rotate the nest jaw clockwise about pivot pin 75 and away from armor cutting blade 50. Spur 67b and boss 69b, present on the obverse sides of lever 52 and nest jaw 53 respectively, as seen in FIG. 2, provide equivalent engagement and drive action between that side of lever 52 and nest jaw 53. As nest jaw 53 rotates clockwise about pivot pin 75, clamp plates 60a and 60b are independently carried in a clockwise direction about pivot pin 75 due to loads applied to them at perch studs 117a and 117b by the end legs of clamp spring 116. The clockwise rotations of clamp plates 60a and 60b are again limited by their contact with body 56 at stop edge 61a of FIG. 14 and opposite side stop edge 61b as seen in FIG. 33.

Thus, a third resultant of opening lever 52 is to rotate nest jaw 53 and clamp plates 60a and 60b away from armor cutting blade 50, and then further rotate nest jaw 53 away from clamp plates 60a and 60b for the purpose of loading armored cable 76 or conduit into position on profile edges 59a & 59b of nest jaw 53.

Thus, the combined result of fully opening lever 52 to a position orthogonal to handle 58 is to open upper & lower nip blades 63 and 65, to relax feed springs 106a & 106b, to move clamp plates 60a & 60b together with nest jaw 53 clear of armor cutting blade 50, and to further spread the nest jaw 53 and clamp plates 60a & 60b for loading of armor.

As shown in FIG. 14, in this fully open position an armored cable 76 or conduit may be loaded into nest jaw 53 and seated against nest profile edges 59a & 59b for clamping and cutting by the tool. Alternately, in this fully open position conductors may be positioned between upper & lower nip blades 63 & 65 for cutting by the tool.

### Independent Articulation of Clamp Plates

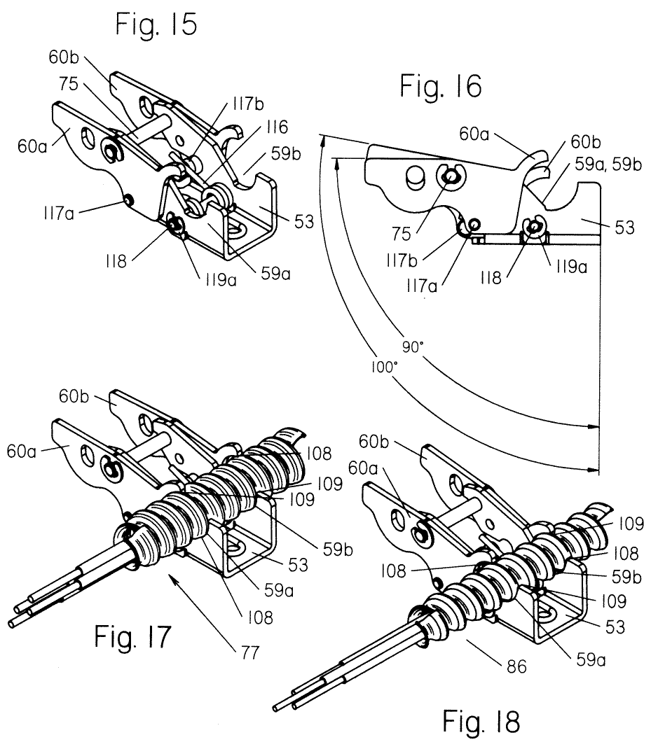

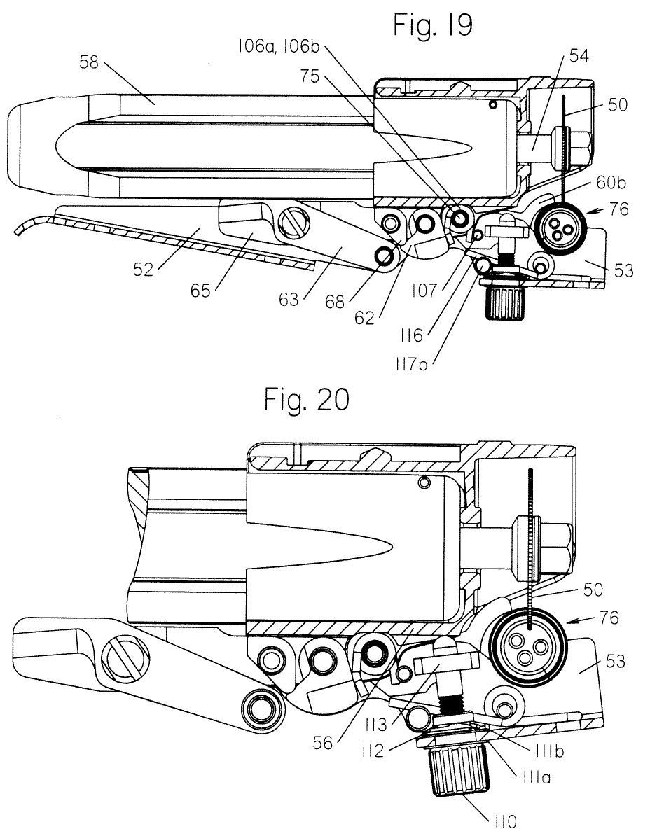

In FIGS. 15 and 16, independent spring loading and angular articulation of clamp plates 60a & 60b with respect to nest jaw 53 is shown. Clamp spring 116 is comprised of two torsional coiled elements wound in opposite directions from a shared central leg. It is carried on shaft 118 which is held in nest jaw 53 by retainer clip 119a on the near side and retainer clip 119b on obverse side as shown in FIG. 33. The shared central leg of clamp spring 116 abuts the inner bottom surface of nest jaw 53 with end legs of the two coiled sections bearing on perch studs 117a and 117b. Perch studs 117a & 117b are fixedly attached to clamp plates 60a & 60b respectively. As such, the two end legs of clamp spring 116 impose a rotational moment about pivot pin 75 on their respective clamp plate, thereby driving the clamp plate to close and clamp upon armor placed on profile edges 59a & 59b of nest jaw 53.

In the embodiment illustrated in FIG. 16, a differential angular articulation between clamp plates 60a & 60b relative to nest jaw 53 is seen as nominally ten degrees of rotation about pivot pin 75. By way of this independent angular articulation of the clamp plates with respect to the nest jaw, armored cables and conduits of differing diameter, material, spiral pitch & interlock form can be loaded, securely clamped and cut. Readily apparent is the ability to provide other equally functional degrees of angular clamp plate articulation by way of embodiments with alternate clamp plate and nest jaw dimensions and geometries.

Referring to FIGS. 17 and 18, the described independent articulation and spring loading of clamp plates 60a & 60b on differing armors is shown. For example, in FIG. 17 one common size & form of steel armored cable 77 is shown positioned into nest jaw 53. In FIG. 18, a differing but also common size & form of aluminum armored cable 86 is shown positioned into nest jaw 53.

Upon placement in nest jaw 53, the undulate outer surface of these differing armors will seat randomly in the nest jaw profile edges 59a & 59b with armor high and low points 108 & 109 contacting a plurality of adjacent points against said profile edges. Rotation of lever 52 to the fully closed position as previously described will then cause clamps plates 60a & 60b to close independently and clamp upon said armor high and low points, regardless of the effective armor diameter and shape at the points of contact.

For the examples shown in FIGS. 17 and 18, clamp plates 60a & 60b and nest profile edges 59a & 59b can be seen to locate and clamp effectively on the differing armor high points 108 and armor low points 109. As a result, the inventive tool readily accepts, securely clamps upon and cuts a variety of armor types and sizes without requiring adapters, inserts or adjustments by the operator.

### Armor Clamping, In-Feed & Depth Stop

Referring to FIGS. 15, 16 &19, an armored cable 76 is shown loaded into nest jaw 53 and lever 52 has been returned to the fully closed position parallel to and against handle 58. In this state, the armored cable or conduit is clamped in nest jaw 53 by clamp spring 116 acting on clamp plates 60a & 60b and perch studs 117a & 117b.

Concurrent with the armor clamping action effected by returning lever 52 to the fully closed position is a reversal of the previously described actions between lever 52, nip blades 63 & 65, integral drive cam 68, transfer cam 62 and feed springs 106a & 106b. As a result, the feed springs are now torsionally compressed by the action of cams 62 and 68, thereby loading spring stop 107 and rotating the nest jaw, clamp plates and clamped armor about pivot pin 75 until the armor contacts armor cutting blade 50. Positioned and loaded as such, the armor is securely clamped, ready to be cut and will self-feed into the blade under the load of feed springs 106a & 106b as shaft 54 is rotatably driven and the armor cut proceeds.

Referring to FIG. 20, depth of cut into the armor is made adjustable so that varied armor diameters and spiral wrap forms may be cut deep enough to separate the armor without cutting any conductors contained within.

Threaded thumb nut 110 is held captive axially under tension in nest jaw 53 by bowed E-clip 112 but remains free to rotate. Polymer slip washers 111a & 111b provide controlled friction to maintain a setting while yielding to allow rotational adjustment of the thumb nut. Threaded within thumb nut 110 and constrained against rotation within the sides of nest jaw 53 is stop stud 113, which will extend or retract relative to nest jaw 53 with rotation of said thumb nut. The resultant effect is to present the non-threaded distal end of stop stud 113 against body 56 as an adjustable depth stop for feeding the armored cable 76 into armor cutting blade 50 to an adequate but not excessive depth, thus separating the armor without cutting any contained conductors.

Upon completion of the armor cutting operation, the spirally wound armored cable 76 will contain a longitudinal armor cut 78 as seen in FIG. 1. Lever 52 may now be returned to the fully open position wherein the cable 76 is unclamped and may be removed from nest jaw 53.

### Cutting of Conductors

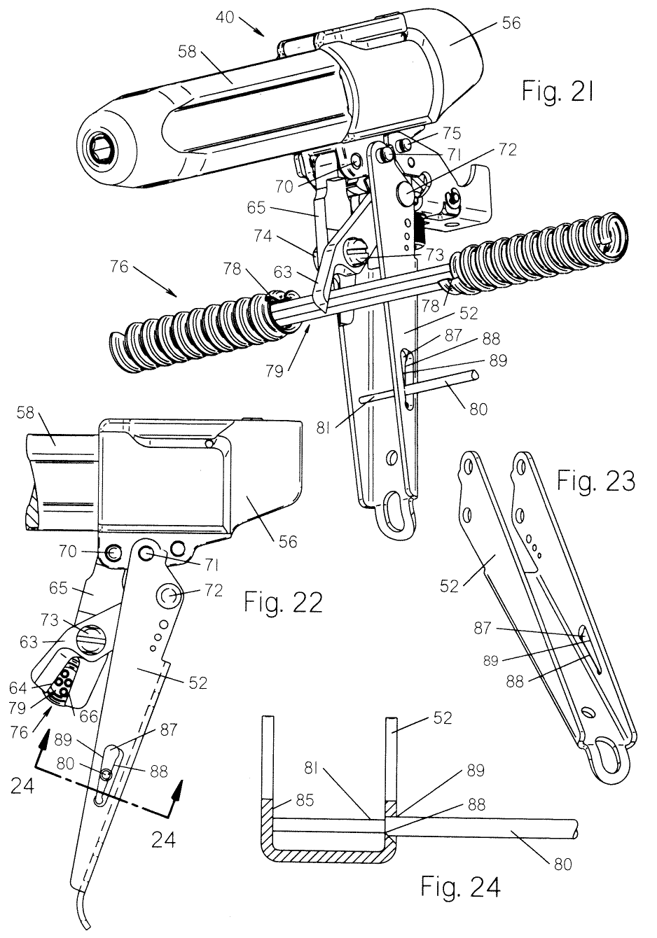

Referring to FIGS. 21 and 22, tool 40 is shown with the armor of cable 76 cut as previously described and separated at the points of armor cut 78 to expose conductors 79. Lever 52 has been rotated away from handle 58 about pivot pin 71 to the fully opened position to extend and open nip blades 63 and 65. The exposed portions of conductors 79 are inserted between cutting edges 64 & 66 of the nip blades 63 & 65. Manual force may then be applied by the user to close lever 52 against handle 58, thereby severing the wires as cutting edges 64 & 66 pivot closed about shoulder bolt 73.

Referring again to FIGS. 21 & 22, lever 52, body 56, upper nip blade 63 and lower nip blade 65 are seen to comprise a kinematic 4-bar linkage. Body 56 represents the fixed link with dowel 70 and pivot pin 71. Lever 52 comprises a moving link with pivot pins 71 and 72.

Lower nip blade 65 comprises a second moving link with dowel 70 and shoulder bolt 73 retained by lock nut 74. Upper nip blade 63 comprises the third moving link with pivot pin 72 and shoulder bolt 73.

As shown the linkage generates a compound leveraged multiplication of the closing forces applied between lever 52 and handle 58 as understood by those skilled in the art. These multiplied forces are transferred to the conductors at cutting edges 64 & 66 of said nip blades.

Thus, the multiplied forces enable the simultaneous cutting of more conductors and larger conductors than simple single-pivot 2-link cutters for a given user-applied manual force.

### Stripping of Conductor Ends

A first embodiment comprises a lachrymiform stripper aperture 87 made integral to lever 52 as shown in FIG. 21 through FIG. 24, and includes sharpened edge 88 and unsharpened edges 89. It accepts cut wire ends of various insulation and conductor diameters and uniformly strips them of insulation for electrical connection.

In practice, cut wire end 80 is inserted through the large end of stripper aperture 87 until stopped at surface 85 of lever 52, thereby setting a controlled and repeatable strip length. Insulated wire end 80 is then manually pushed toward the small end of stripper aperture 87 whereby unsharpened edge 89 effectively forces wire end 80 into sharpened edge 88 to cut through the wire insulation. Wire end 80 and tool 40 are then rotated relative to one another with respect to the longitudinal axis of the wire, thereby causing sharpened edge 88 to slice circumferentially through the insulation. Wire end 80 may then be pulled from the aperture with the cut portion of insulation being removed or “stripped’ in the process, leaving the stripped wire end 81 presenting a bare conductor section of controlled & repeatable length.

In the embodiment shown, the aperture readily accepts common insulated wire of types THHN and THWN in AWG (American Wire Gauge) of #14, #12 and #10 AWG, but as readily understood could be located and sized differently to accept other wire types and gauges without altering its insulation stripping functionality.

### Replaceable Stripper Embodiment

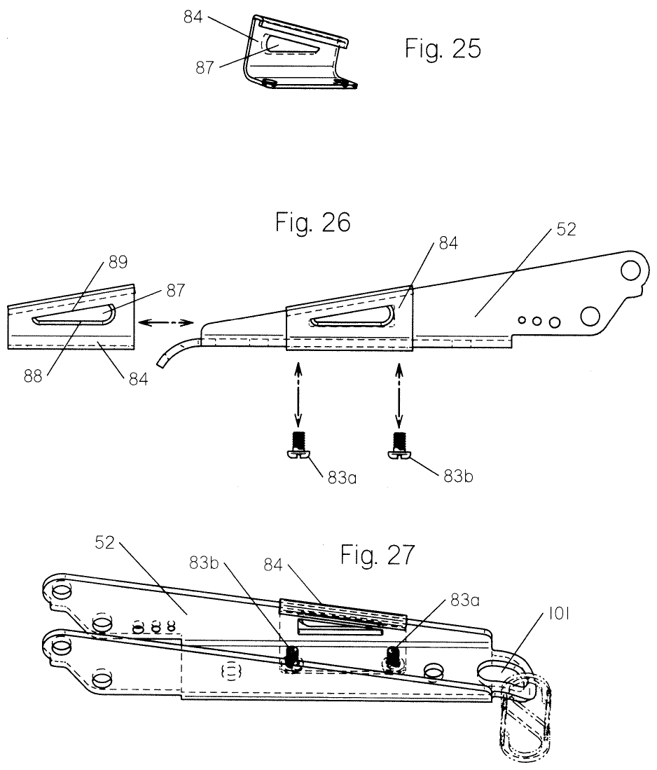

In an alternate embodiment of the wire stripping feature, the lachrymiform stripper aperture 87 is made part of replaceable stripper insert 84 as shown in FIGS. 25 through 27, thereby allowing for replacement of dulled edges or for interchange with apertures sized for alternate wire types and diameters. The sharpened edge 88 and unsharpened edge 89 act to strip insulation from a wire end as described above with the integral aperture. Insert retaining screws 83a & 83b provide for retention of the insert on lever 52 while allowing removal for replacement or interchange.

### Utility Hook Provision

Referring to FIG. 1 and FIG. 27, ovoid hole 101 in lever 52 provides for attaching tool 40 to the user's belt or tool pouch by way of an ordinary clasp or hook, shown in phantom.

### Wire End Loop Forming

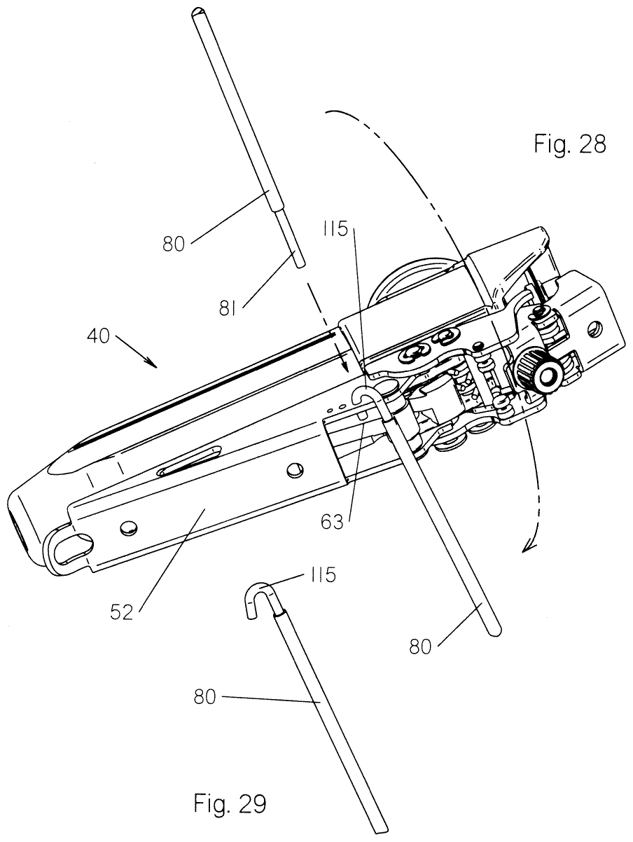

Referring to FIG. 1 and FIG. 28, looping aperture(s) 90 are incorporated integral to lever 52. In the embodiment shown, three (3) apertures are provided and sized for common wire gauges of 14, 12 and 10 AWG (American Wire Gauge), but other embodiments may include any number of apertures diametrically sized for other predetermined wire gauges.

The looping apertures provide for the rapid, uniform & repeatable bending of stripped wire ends into semi-circular loop forms as commonly used for producing secure electrical connections to standard wiring devices such as switches, receptacles and terminal blocks.

In use, the stripped wire end 81 of wire end 80 is inserted into the appropriate looping aperture 90 based on its wire gauge, until stopped by upper nip blade 63. With the stripped wire end thus inserted, the extensive portion of wire end 80 is manually displaced about the restrained stripped wire end 81. Upon removal from the aperture, the stripped wire end 81 will have been formed into looped wire end 115 as shown in FIG. 29.

### Spare Blade Storage

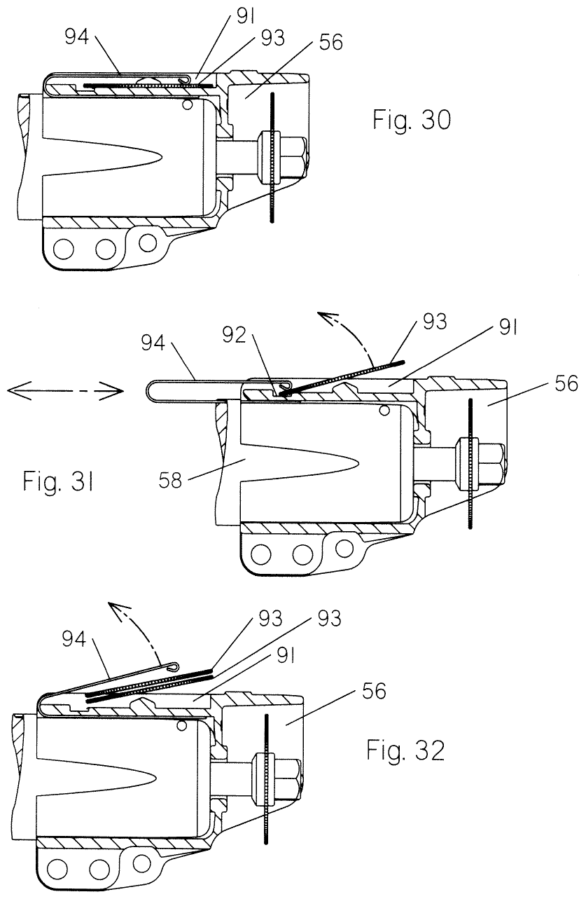

Referring to FIG. 30, body 56 includes recess 91 which provides storage for one or more spare armor cutting blades 93. As shown, spare armor cutting blade 93 is statically retained within recess 91 under force from spring clip 94.

In FIG. 31, one embodiment of the spare blade storage feature is shown in which spring clip 94 is fitted so as to slide longitudinally within body 56 and along handle 58. As spring clip 94 is slidably retracted toward the distal end of handle 58 and reaches the end of recess 91, its' spring load causes the perimeter of the spare blade 93 to drop into secondary recess 92, thereby causing the spare blade 93 to pivotably rotate out of recess 91 for easy retrieval. Insertion of a spare blade for storage is effected by reversal of this slide action of spring clip 94, returning it to the position spanning recess 91 and thus retaining the spare blade(s).

FIG. 32 shows an alternate embodiment wherein spring clip 94 is flexurally deflected from the static closed position to allow insertion or retrieval of spare blades 93 from recess 91 of body 56.

### Obverse View of the Tool

In FIG. 33 an isometric view from the obverse side of tool 40 shows components and features not readily visible in other figures.

Referring to FIG. 34, an enlarged detail from FIG. 33 shows specifically feed springs 106a & 106b carried co-axially on pivot pin 75, slip washer 111a installed between thumb nut 110 and nest jaw 53, and spacers 104a & 104b installed on pivot pin 72 and retained in assembly by clip 120 thereby centering upper nip blade 63 between the parallel sides of lever 52.

I do hereby claim:

1. A tool for preparing flexible armored cables and conduits, the tool comprising:
a shaft rotatably carried in a plurality of bearings;
an armor cutting blade attachable to said shaft;
a handle of elongate cylindrical form through which said shaft passes and wherein said bearings are carried;
a nest jaw comprising a plurality of profile edges to engage upon and locate a flexible armored cable or conduit;
a plurality of clamp plates operable with respect to said nest jaw;
a first and second nip blade operably attached to said tool;
a structural body element operably connecting said shaft, armor cutting blade, handle, nest jaw, clamp plates and nip blades;
a lever operably attached to said body and engaging the nest jaw, clamp plates and nip blades;
an insulation stripper aperture accepting of a plurality of wire gauges;
one or more looping apertures of predetermined size accepting of stripped wire ends,
wherein:
the armor of a flexible armored cable or conduit is positioned and cut with power assisted rotation of the shaft and blade;
conductors contained within the armored cable are cut by means of the operably attached nip blades;
cut ends of said conductors are stripped of insulation by means of the stripper aperture;
stripped conductor ends may be formed by means of the looping apertures,
thereby efficiently producing a fully finished, flexible armored cable or conduit portion using the single, handheld portable tool.

2. The tool according to claim 1, wherein the shaft and armor cutting blade rotational driving mechanism comprises a recess that accepts a mating drive bit, wherein said drive bit is rotatably powered by a user supplied electric drill or drill driver.

3. The tool according to claim 2, wherein the recess comprises a fixed magnet at its interior end to retain the drive bit in storage for ready access.

4. The tool according to claim 1, wherein the shaft and armor cutting blade rotational driving mechanism comprises an electric motor, a gear reducer, and one or more batteries to deliver rotational drive power to said shaft and said armor cutting blade.

5. The tool according to claim 4 wherein said batteries are contained in a battery pack made attachable and detachable to the tool.

6. The tool according to claim 1 comprised of opposed elastomeric rings abutting at least one of said bearings to compliantly locate said shaft longitudinally within the handle relative to the body.

7. The tool according to claim 1 wherein the first and second nip blades are pivotably interconnected to one another and to said body and lever thereby forming a four bar linkage whereby a user applied force between the lever and handle is multiplied into a greater force acting between the cutting edges of the nip blades.

8. The tool according to claim 1 comprised of a stripper aperture accepting of a plurality of insulated wire gauge sizes.

9. The tool according to claim 8 wherein the stripper aperture is made removable from the tool for the purpose of replacing it when dulled, or for interchanging it with stripper apertures sized for alternate wire types and diameter gauges.

10. The tool according to claim 1 comprised of one or more loop forming apertures, each being diametrically sized to accept a predetermined standard wire gauge, wherein an inserted wire end is restrained while its unrestrained portion is displaced about said aperture thereby producing a uniform loop form on the wire end.

11. The tool according to claim 1 whereby rotation of the lever about its pivot produces opening and closing actions at the nest jaw and clamp plate thereby enabling loading and unloading of a flexible armored cable or conduit.

12. The tool according to claim 1 whereby rotation of the lever about its pivot torsionally loads or unloads a clamp spring acting on the clamp plates, thereby retaining or releasing the flexible armored cable or conduit positioned in the tool.

13. The tool according to claim 12 wherein the clamp plates are independently articulated relative to the nest jaw thereby accepting of and securely clamping upon a plurality of sizes and forms of armored cable and conduit.

14. The tool according to claim 1 whereby rotation of the lever about its pivot torsionally loads or unloads feed springs acting on the nest jaw whereby the armor of a cable or conduit is progressively fed into the rotating armor cutting blade.

15. The tool according to claim 14 wherein the mechanism to torsionally load and unload the feed springs is comprised of a drive cam and a transfer cam operably connected to transfer motion of the lever to the feed springs.

16. The tool according to claim 1 comprised of a user adjustable stop stud acting between the nest jaw and body whereby the depth of the armor cut into a plurality of armor sizes and types may be controlled.

17. The tool according to claim 1 comprised of a spring clip acting with one or more integral body recesses whereby spare armor cutting blades are retained or retrieved.

18. The tool according to claim 1, comprising an ovoid hole configured to accept a clasp or hook to attach said tool to a belt, or tool pouch.

19. A method for preparing flexible armored cable and conduit, the method comprising:
loading a section of flexible armored cable or conduit into position in a nest jaw of a tool by way of an opening action applied to a lever;
clamping the flexible armored cable or conduit section into the nest jaw by way of a closing action of the lever of the tool;
cutting the armor of the flexible armored cable or conduit section with power assisted rotational drive applied to a shaft and attached armor cutting blade as said armor is fed into the blade under spring load;
cutting conductors contained within the cut armor section by lever action acting on first and second pivotably connected nip blades of said tool;
stripping insulation from the cut conductor ends by means of a stripper aperture element of said tool; and
forming loops on the stripped ends of the conductors by means of at least one looping aperture element of said tool, thereby producing a completely prepared flexible armored cable or conduit from bulk material using a single handheld portable tool.
